(19) United States
(12) Patent Application Publication
(10) Pub. No.: US 2003/0151699 A1
(43) Pub. Date: Aug. 14, 2003

(54) Double remote system

(76) Inventors: Joseph D. Pokorski, Depew, NY (US); James R. Engler, Depew, NY (US)

Correspondence Address: Kevin D. McCarthy, Hodgson Russ LLP, Suite 2000, One M&T Plaza, Buffalo, NY, 14203-2391, US

(21) Appl. No.: 10/200,827

(22) Filed: Jul. 22, 2002

Related U.S. Application Data
(60) Provisional application No. 60/356,863, filed on Feb. 14, 2002.

(51) Int. Cl. H04N 5/30; H04N 5/335; H04N 5/50; H04N 5/44

(52) U.S. Cl. 348/734; 348/731; 348/162

(57) ABSTRACT

The present invention addresses some of those drawbacks of the prior art through a television control system that controls different models of predetermined number of hospital televisions by measuring the TV's distinct voltage level. The control system is connected to an operating hospital television and has an input device, a controller, a first and second set of control signals, and a voltage reader device. The input device is operable for generating at least one television input signal that corresponds to a television input from a person. The first set of control signals have at least one individual control signal designed to correspond to a first hospital television which is one of the predetermined number of hospital televisions. The second set of control signals have at least one individual control signal designed to correspond to a second hospital television which is one of the predetermined number of hospital televisions, and not the one controlled by the first set of control signals. The voltage reader device determines the voltage level of a operating hospital television and depending on the voltage level configures the controller to transmit either the first set of control signals or the second set of control signals. The control system automatically operates the operating hospital television in response to a patient input.

### CLAIM OF PRIORITY

This application is a non-provisional application that claims priority to provisional application Serial No. 60/356,863 filed on Feb. 14, 2002.

### FIELD OF THE INVENTION

This invention relates generally to hospital interfacing devices and particularly to an interface device for controlling a television in a hospital room. The term “hospital”, as used in this application, means a hospital and every other type of health care facility.

### BACKGROUND OF THE INVENTION

Televisions (TVs) manufactured for use in health care facilities, such as within hospital rooms, are specifically designed for use within those environments. In the past, such televisions have been designed to meet certain requirements regarding safety and control. However, such hospital TV control has always been subject to an informal control standard directed to the patient operation of the TVs from a hospital bed rail control or a pillow speaker. The term “pillow speaker” is generally used to refer to a device associated with a hospital bed which provides an audio speaker and volume control for a television, along with capabilities for communicating with the nurse, controlling lighting, and other such features. The pillow speaker is generally a detached unit connected by a cord to the bed or to an interface plug in the wall.

While available hospital TVs and their associated controls provide a basic viewing experience, they suffer from several significant drawbacks. Historically, the control of hospital TVs has been severely limited. These controls generally consisted of a volume control knob or buttons for raising and lowering the volume, and a single button control which turns the television ON and OFF and changes the channel to be viewed. For example, such TVs are turned ON by pressing the TV button. Then, each subsequent depression of the TV button changes the channel UP to the next available viewing channel. When all the available channels are displayed in sequence, the television then turns OFF. Depressing the TV button again turns the television back ON and prepares it again for moving UP through the channels. The patient or other person controlling the TV can only progress upwardly through the channels. If a desired channel is passed, the patient has to progress all the way through the channel selections, has to turn the TV OFF and then ON again, and finally has to move up slowly through the channels, being careful to again not pass the desired channel. Furthermore, a patient cannot turn the TV OFF at a selected channel and then turn it back ON at that channel. The TV always comes back ON at the same channel and the patient has to again search for the channel they were previously viewing.

Such scenarios are not only frustrating and a waste of the patient's time, but may unduly and undesirably aggravate the patient, whose health may not be at its best. While such control may have been at least sufficient when only a few channels were available for viewing, the latest TV technology requires additional control for accessing a large number of additional channels and operating an expanded set of TV features and functions. For example, it is desirable to turn the television ON and OFF and have it remain at the channel which was last selected. Furthermore, it is desirable to move UP or DOWN through the available channels at random. Still further, it is desirable to access a number of other TV features, such as display menus or channel viewing guides. Newly available hospital TVs, often referred to as code-driven TVs, are capable of being functionally controlled as desired and discussed above. However, current hospital TV control technology is usually only able to provide the limited control that has traditionally been available with a hospital TV and often cannot take full advantage of the code-driven TV technology.

Another significant drawback of available hospital TV control technology is that each bed and pillow speaker associated with the bed must be configured to control a specific brand/model (hereinafter “model”) of hospital TV. There are currently at least three major manufacturers of hospital TVS. To control a specific TV model from a hospital bed and pillow speaker, the bed and pillow speaker have to be specially manufactured and configured for that TV model.

As such, a hospital or other health care facility has to know which beds are going to go with which TV models, and the manufacturer of the beds has to tailor and configure the bed operation for the specific TV model. Oftentimes, such configuration is required in the field, which further increases the manufacturing costs associated with each bed. After the beds and TVs are installed, a bed cannot be moved to a room having a different TV model than the one for which it is manufactured and configured. Otherwise, the TV cannot be controlled from the bed. As may be appreciated, this presents significant logistical problems for the hospital in setting up a hospital room. Furthermore, it presents delays in implementing a bed or a pillow speaker into a room, because if the bed and TV do not communicate, then the hospital has to obtain a different bed, or a different TV model or has to have the bed reconfigured for the specific TV model available.

The present hospital TV control scenario is also unsuitable for hospital bed manufacturing. Manufacturers have to keep different beds in inventory, or have to specifically tailor or retrofit each bed to the customer's TV demands. Such retrofitting is often done by the bed manufacturer in the field. This is not only costly in the way of increased inventory costs and post production modifications, but it also creates another issue for manufacturers' Customer Service Departments to handle.

Furthermore, not only do the above problems and drawbacks arise when a new hospital room is being set up, but they will again occur if there is a malfunction in the bed, in the TV, or both. Replacement beds or TVs cannot simply be taken from other rooms unless the hospital only has one type of bed and one model of television.

Any solution to the above drawbacks in current TV control technology must not only take into account the newer code-driven hospital TVs, but must also be compatible with older TVs that will probably remain in a particular hospital until they malfunction or the hospital makes a determination to upgrade to newer TVs. Given the interest in rising health care costs, the former situation may occur before the latter.

Radio capabilities are also usually available with some hospital TVs. In the past, the bed rails and pillow speakers have had separate, generally single button, RADIO controls for turning the radio ON and OFF and changing the radio channels. Furthermore, radio control was limited like the TV control. Therefore, any suitable solutions to the drawbacks of the current TV control technology should also be capable of utilizing available radio features of a television, whether an older TV model or a newer, code-driven model.

In U.S. Pat. No. 6,008,736, Palm et al. disclosed one operandi for a television control system for universal control of hospital televisions. This system has an input device operable for generating at least one control signal corresponding to an input from a person, and a controller configured for interfacing with a hospital television. In the file history of the '736 patent, Palm et al. stated, “The controller automatically generates a control signal cluster which is reflective of the input signal received from the input device. Each control signal cluster that is generated by the controller includes a predetermined number of sequentially generated, individual control signals which correspond to at least one operational function of a plurality of different models of hospital televisions . . . . [The] controller of the inventive television system . . . does not have to be programmed or otherwise specifically configured by the user for its intended purpose . . . .Rather, a control signal cluster associated with the controller includes a predetermined number of sequentially generated individual control signals. That predetermined number corresponds to a predetermined number of models of hospital televisions for which the system is to be used. Each control signal cluster that is generated from patient input will thereby address all of the predetermined number of control signals, and therefore, all of the predetermined models of television for which the system is used”, as shown in FIG. 11. A similar version of this invention is disclosed in U.S. Pat. No. 6,005,486, which is a continuation-in-part of the '736 patent.

A problem with those systems is that it must always send every signal for each television every time the user generates an input signal, when the system is in a particular mode. The mode selection, as taught by Palm et al., “address [es] a number of other possible scenarios within a hospital. While such mode selection is desirable and the inventive system addresses the problems in the prior art, it requires proper switch selection for the desired mode upon installation. Accordingly, the proper switch selection requires an individual to recognize which TVs are in use within a particular room or within a particular hospital or medical facility. Such a determination may slow the installation procedure.” Accordingly, Palm et al. recognize a problem with their system.

In addition to that problem, by sending every signal every time to the television, the internal components of the system will deteriorate faster than if just selected signals are transmitted in accordance with the television.

### SUMMARY OF THE INVENTION

The present invention addresses some of those drawbacks of the prior art through a television control system that controls different models of predetermined number of hospital televisions by measuring the TV's distinct voltage level. The control system is connected to an operating hospital television and has an input device, a controller, a first and second set of control signals, and a voltage reader device. The input device is operable for generating at least one television input signal that corresponds to a television input from a person. The first set of control signals have at least one individual control signal designed to correspond to a first hospital television which is one of the predetermined number of hospital televisions. The second set of control signals have at least one individual control signal designed to correspond to a second hospital television which is one of the predetermined number of hospital televisions, and not the one controlled by the first set of control signals. The voltage reader device determines the voltage level of a operating hospital television and depending on the voltage level configures the controller to transmit either the first set of control signals or the second set of control signals. The control system automatically operates the operating hospital television in response to a patient input.

### BRIEF DESCRIPTION OF THE DRAWINGS

FIG. 1 is a block diagram of an embodiment of the control system present invention;

FIG. 2 is a circuit schematic of the system in FIG. 1;

FIG. 3 is a flow chart illustrating the operation of one embodiment of the inventive system;

FIGS. 4-7 and 14 are flow charts illustrating alternative embodiments of FIG. 3;

FIGS. 8-10, 12, and 13 illustrate control sequence diagram operations of the present invention;

FIG. 11 is a control sequence diagram for operation of the prior art.

FIGS. 15A and B are alternative embodiments of FIG. 2 as shown in Box 15.

### DETAILED DESCRIPTION OF THE INVENTION

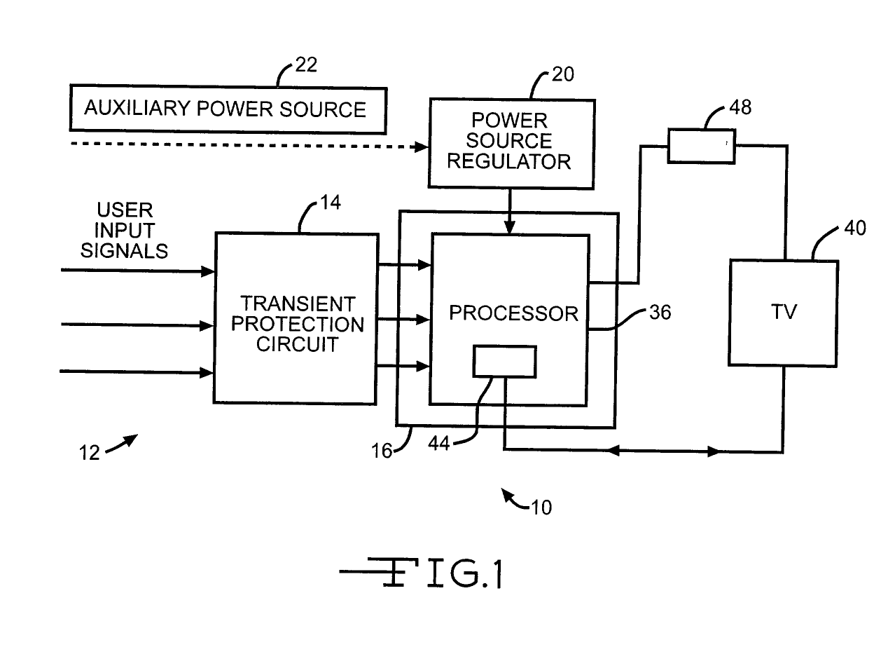

FIG. 1 is a block diagram of a system for use in a hospital or other health care facility implementing a television control system of the present invention. System 10, illustrated in FIG. 1, provides the necessary interface between the patient, the bed, the control system, and the TV. System 10 implements a plurality of user inputs 12 which are preferably provided by the bed rail circuitry of a hospital bed or the circuitry of a pillow speaker. In currently available hospital beds and pillow speakers with TV control systems, control buttons are available for operating the bed, operating the television, operating a radio, operating a computer, calling a nurse or other attendant, and a variety of other functions associated with hospital beds. While the input devices are traditionally bed rails and pillow speakers, other input devices might be used.

The controller 16, discussed in greater detail hereinbelow, includes a processor 36 which provides the necessary signals, in the form of a coded data stream on output lines 28 for controlling the hospital TV in accordance with the principles of the present invention. Controller 16 is preferably coupled to an appropriate power source and regulator circuitry 20, such as power from a hospital bed or the hospital TV. System 10 also preferably includes an auxiliary power source 22, such as battery, when a more standard source of power is unavailable.

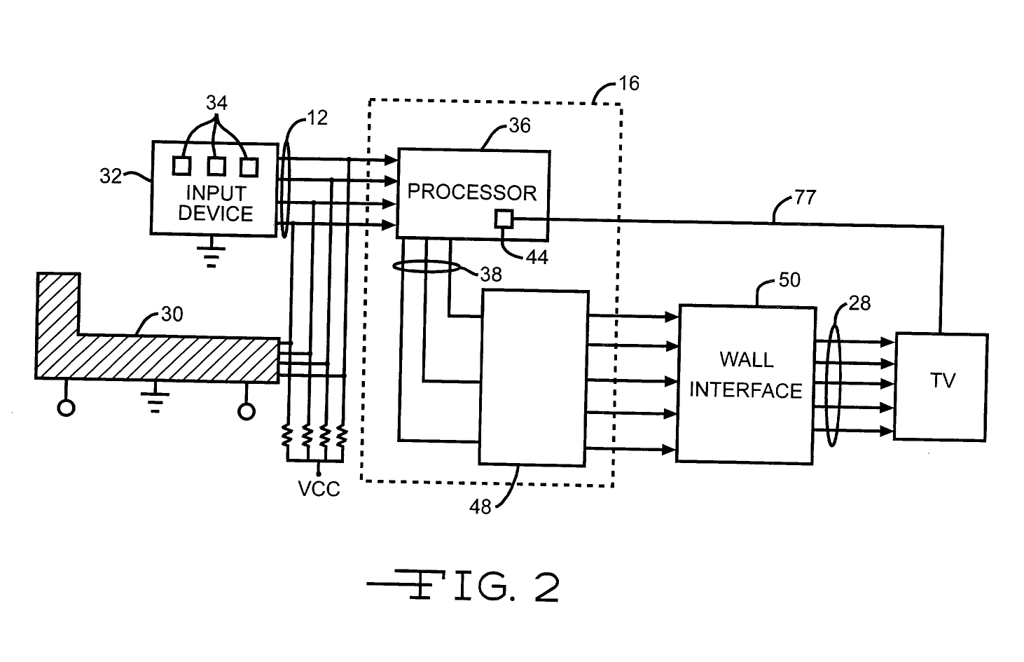

FIG. 2 is a circuit schematic diagram for the controller 16 of system 10 illustrated in FIG. 1. In accordance with the principles of the present invention, a patient or other person is able to control only one of a variety of different TV models using input buttons, switches, or other devices on a hospital bed rail, pillow speaker, or similar input device. Throughout this application, the term “models” used in referring to the different types of hospital TVs which are available, refers both to different brands of hospital TVs made by different manufacturers, such as RCA/GE, Zenith, and Magnavox/Philips, and also refers to the different types of models which may be available from any one manufacturer but which may require a different control protocol.

To control the hospital TV in accordance with the principles of the invention, user inputs or input signals 12 are provided to controller 16 from the existing TV control circuitry of a hospital bed 30, or from another input device 32, such as a pillow speaker. For example, a user input might be the operation of a button, switch or other device on the bed or pillow speaker. The TV control input circuitry of a bed will generally be located at the available left and right side rails of the bed (not shown) as is conventional. However, it will be understood that other locations on the bed may also be suitable for the TV control input circuitry. The input circuitry preferably includes a number of input buttons/switches 34, as shown on the pillow speaker 32, which may be pressed or activated by a patient. It is also conventional to locate TV control buttons on the pillow speaker. While the pillow speaker 32 and bed 30 may be used exclusive of each other for TV control, a pillow speaker will generally be provided with the bed, and in such a case, the inputs from the various devices may be operably tied together as illustrated in FIG. 2. The various available user inputs will preferably generate input signals. FIG. 2 shows four input lines which make up the user input signals 12. However, a lesser or greater number of inputs, input signals and appropriate lines may be provided depending upon the number of input buttons/switches 34 utilized with the bed or pillow speaker and the desired control of the TV.

Controller 16 further comprises a processor 36 which is preferably a conventional integrated circuit micro-processor, such as a Microchip PIC 16F627. Alternatively, the processor 36 might include a programmable logic array (PLA) which is specifically configured for use within the controller 16 in accordance with the principles of the present invention. The processor 36 is operably coupled to the input devices 30, 32 for receiving input signals 12 therefrom which correspond to the input buttons/switches 34 accessed by the patient. The processor reads the user input signals 12, and depending upon the processor's operational mode, as discussed further hereinbelow, processor 36 will generate at least one output signal 28 necessary for controlling a hospital TV 40 coupled to system 10 of the invention.

In one embodiment of the invention, the processor 36 has an analog to digital converter chip 44 for controlling the operating mode of the processor. The chip 44 is directly connected to the TV 40 through signal 77. Signal 77 is transmitted by chip 44 to the TV 40 to measure the voltage level of the TV 40. The signal 77 is then re-transmitted to the chip 44, as shown in FIG. 2.

Once the voltage level is determined, the chip 44 programs the processor 36 to transmit which of at least two signals 28. Turning to FIG. 3, the chip 44 reads the voltage level of the TV 40. If the voltage level is above a predetermined voltage level, the processor 36 transmits a first set of signals 28a which operates at least a first TV 40a and never a second TV 40b. In contrast, if the voltage level is below the predetermined voltage level, the processor 36 transmits a second set of signals 28b which operates at least the second TV 40b, never the first TV 40a.

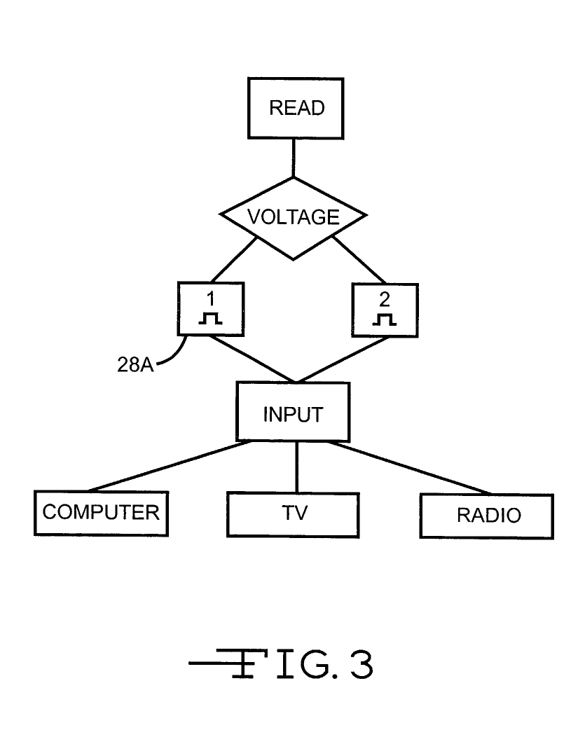

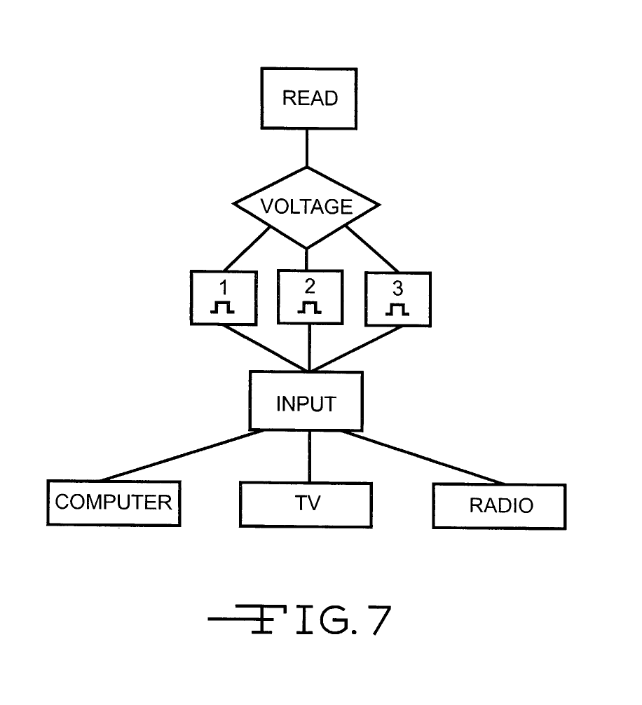

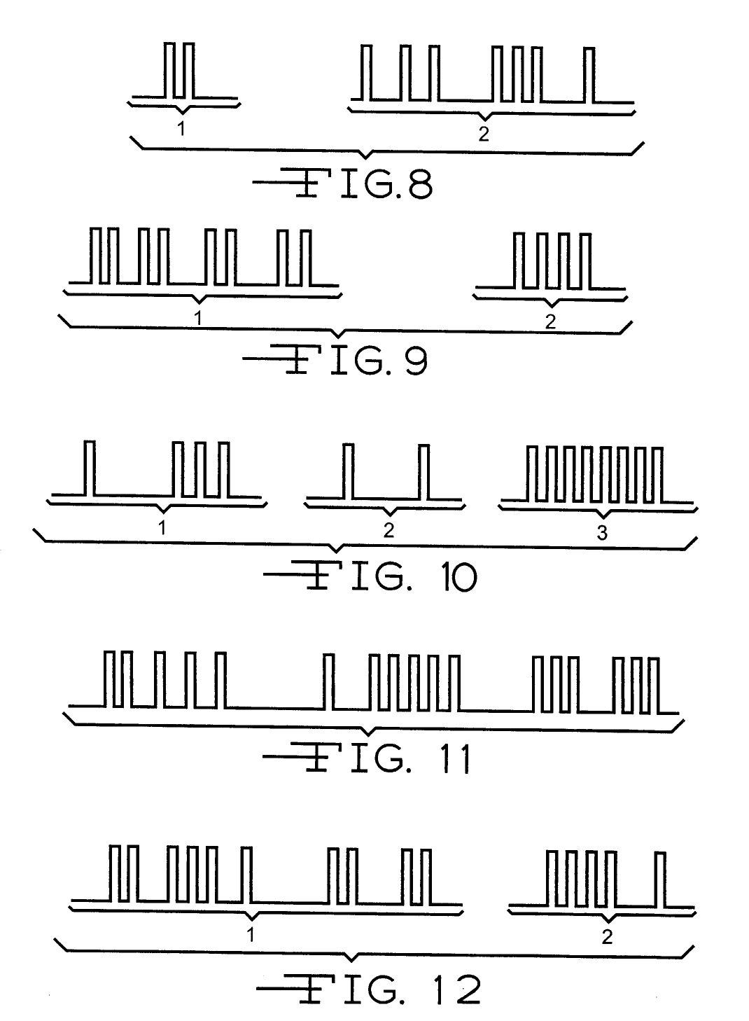

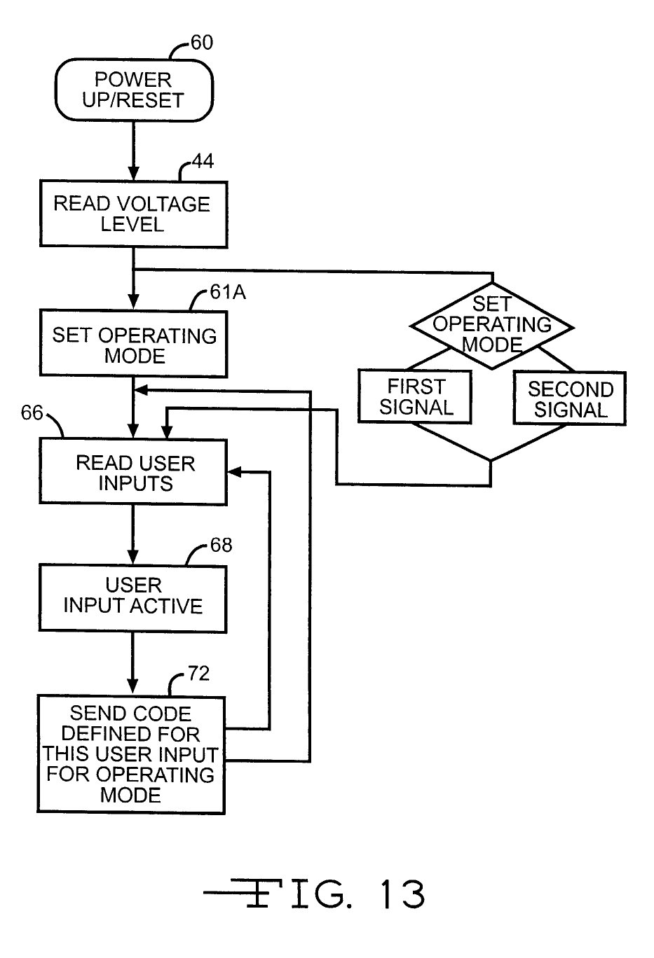

As shown in FIG. 4, the chip 44 reads the voltage level of the TV 40. If the voltage level is above a predetermined voltage level, the processor 36 transmits a first set of signals 28a which is a set of sequentially generated, individual control signals. Each of the individual first set of control signals corresponds to at least one model of a predetermined plurality of different models of hospital televisions which could be the first TV 40a or a third TV 40c, but never the second TV 40b. In contrast, if the voltage level is below the predetermined voltage level, the processor 36 transmits a second set of signals 28b which operates at least the second TV 40b, not the first or third TV's 40a, c. The plurality of signals 28 in accordance with this embodiment is illustrated in FIG. 9.

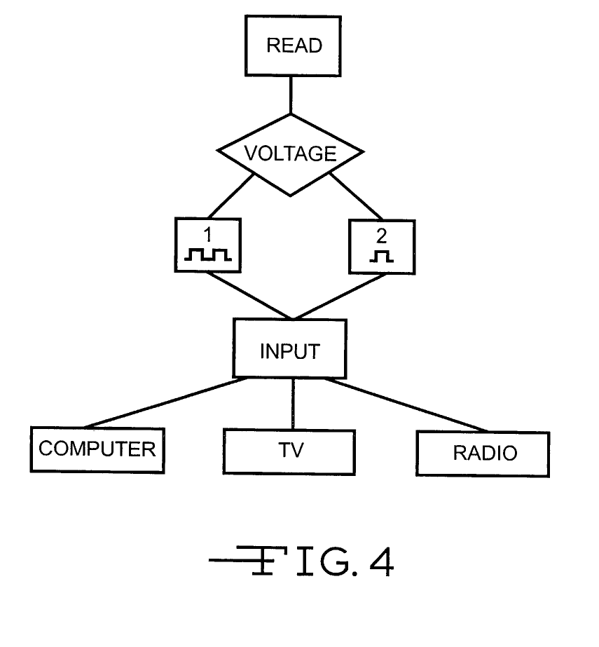

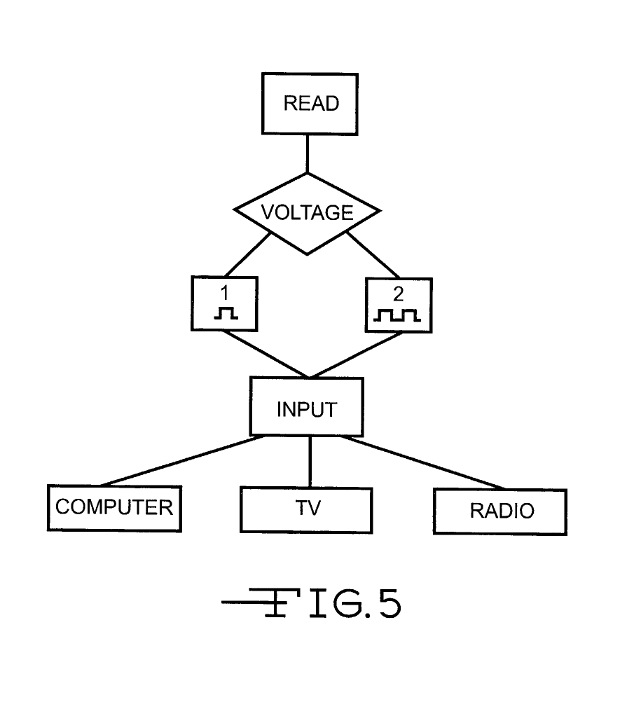

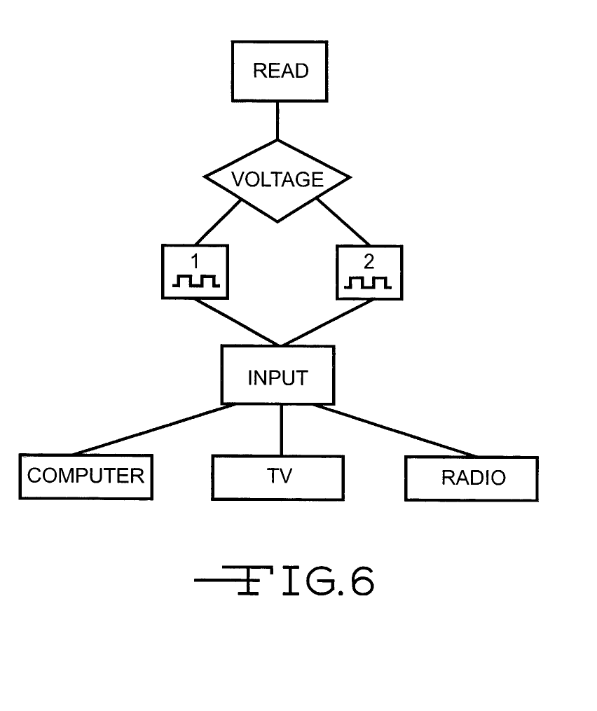

As shown in FIG. 5, the chip 44 reads the voltage level of the TV 40. If the voltage level is above a predetermined voltage level, the processor 36 transmits a first set of signals 28a which is either a single control signal or a set of sequentially generated, individual control signals. Each of the individual first set of control signals corresponds to at least one model of a predetermined plurality of different models of hospital televisions which could be just the first TV 40a. In contrast, if the voltage level is below the predetermined voltage level, the processor 36 transmits a second set of signals 28b which is a set of sequentially generated, individual control signals. Each of the individual second set of control signals corresponds to at least one model of a predetermined plurality of different models of hospital televisions which could be the second TV 40b or a fourth TV 40d, but never the first TV 40a. The plurality of signals 28 in accordance with this embodiment is illustrated in FIG. 8.

As shown in FIG. 6, the chip 44 reads the voltage level of the TV 40. If the voltage level is above a predetermined voltage level, the processor 36 transmits a first set of signals 28a which is a set of sequentially generated, individual control signals. Each of the individual first set of control signals corresponds to at least one model of a predetermined plurality of different models of hospital televisions which could be the first TV 40a or a third TV 40c, but never the second TV 40b. In contrast, if the voltage level is below the predetermined voltage level, the processor 36 transmits a second set of signals 28b which is a set of sequentially generated, individual control signals. Each of the individual second set of control signals corresponds to at least one model of a predetermined plurality of different models of hospital televisions which could be the second TV 40b or a fourth TV 40d, but not the first or third TVs 40a, c. The plurality of signals 28 in accordance with this embodiment is illustrated in FIG. 12.

As shown in FIG. 7, the chip 44 reads the voltage level of the TV 40. If the voltage level is above a first predetermined voltage level, the processor 36 transmits a first set of signals 28a which operates at least the first TV 40a. In contrast, if the voltage level is below the first predetermined voltage level and above a second predetermined voltage level, the processor 36 transmits a second set of signals 28b which operates at least the second TV 40b. If the voltage level is below the second predetermined voltage level, the processor 36 transmits a third set of signals 28c which operate at least the third TV 40c. The plurality of signals 28 in accordance with this embodiment is illustrated in FIG. 10.

In any of the above-identified embodiments, the signals 28 are sent to a transistor 48, for example National Semiconductor's Part no. 2N3904. The transistor 48 merely alters the signal 28 to be transmitted through a wall interface 50 to the TV 40 for controlling the TV 40.

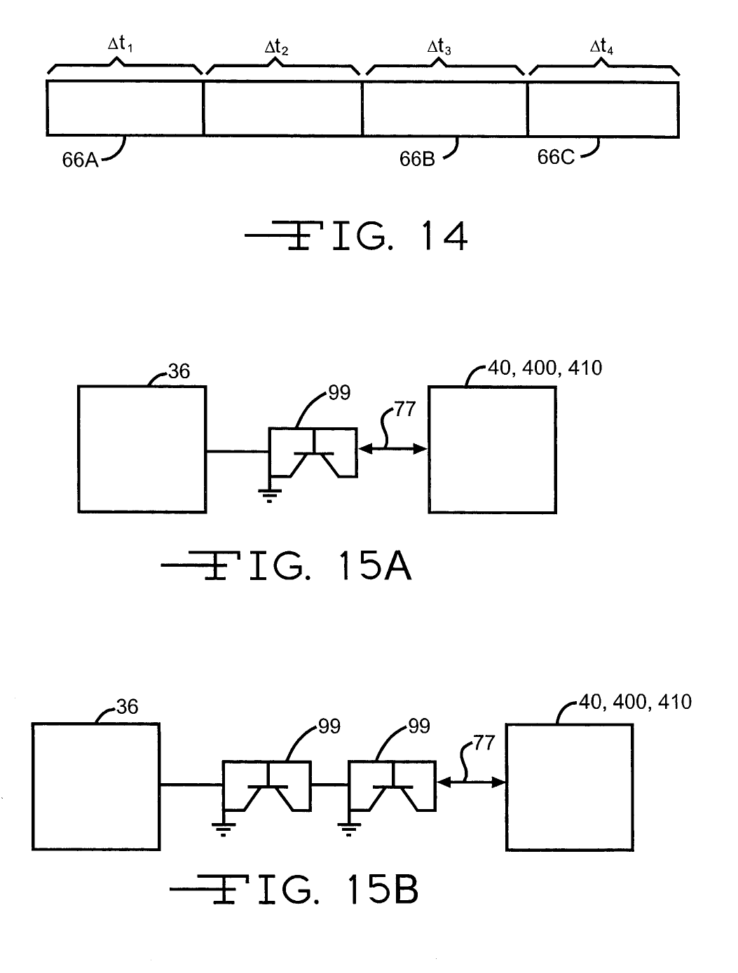

Alternatively, the chip 44 could be a single conventional field effect transistor 99 if there are just two types of signals 28 to be sent, or a series of field effect transistors that allow multiple signals to be sent by the processor 36 as shown in FIGS. 15A, 15B. Preferably, the chip 44 is within the processor 36, as shown in FIG. 2.

When the signals 28 are a set of sequentially generated, individual control signals, as illustrated in FIG. 14, there is a predetermined time frame, or a delay 66a, b, between each signal 28a, b, c. This delay 66a, b, allows the TV 40 to distinguish between the relevant signals. The delay 66a, b may be the same or different durations, therefore the delay is identified as Δt_{1, 3}.

In any of these embodiments, once the voltage level has been determined and the proper signal 28 has been allocated in processor 36, the system waits for the user to input the desired operation to the TV 40, a computer 400, or a radio 410, the latter two of which can be operated by the same method as the TV by the present invention. In any case, the user input 12 is read and then the appropriate coded signal (ON, OFF, Volume Up, Volume Down, Channel Up, Channel Down, Select) is transmitted by the processor 36 to the operable unit (TV, computer, and/or radio). The system then reverts to waiting for the next user input.

The device 10 can be incorporated into a conventional hand-held unit, a conventional health care bed (the term health care bed is any bed like apparatus used by an individual), a chair, a couch, or any other piece of furniture that a user or a subject may want to be entertained from.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

What is claimed is:

1. A television control system for control of different models of predetermined number of hospital televisions that each have a distinct voltage level, the control system connected to an operating hospital television comprising:
an input device operable for generating at least one television input signal corresponding to a television input from a person;
a first set of control signals having at least one individual control signal designed to correspond to a first hospital television which is one of the predetermined number of hospital televisions;
a second set of control signals having at least one individual control signal designed to correspond to a second hospital television which is one of the predetermined number of hospital televisions;
a voltage reader device that determines the voltage level of a operating hospital television and depending on the voltage level configures a controller to transmit either the first set of control signals or the second set of control signals;
the control system automatically operating the operating hospital television in response to a patient input.

2. The control system of claim 1 wherein the second set of control signals further comprises a predetermined set of sequentially generated, individual control signals, each of the individual second set of control signals corresponds to at least one model of a predetermined plurality of different models of hospital televisions, one of which is the second hospital television and another is a third hospital television, but not the first hospital television.

3. The control system of claim 1 wherein the system has a third set of control signals having at least one individual control signal designed to correspond to a third hospital television which is one of the predetermined number of hospital televisions.

4. The control system of claim 1 wherein the first set of control signals further comprises a predetermined set of sequentially generated, individual control signals, each of the individual first set of control signals corresponds to at least one model of a predetermined plurality of different models of hospital televisions, one of which is the first hospital television and another is a third hospital television, but not the second hospital television.

5. The control system of claim 1 wherein the first set of control signals further comprises a predetermined set of sequentially generated, individual control signals, each of the individual first set of control signals corresponds to at least one model of a predetermined plurality of different models of hospital televisions, one of which is the first hospital television and another is a third hospital television, but not the second hospital television; and the second set of control signals further comprises a predetermined set of sequentially generated, individual control signals, each of the individual second set of control signals corresponds to at least one model of a predetermined plurality of different models of hospital televisions, one of which is the second hospital television and another is a fourth hospital television, but not the first hospital television.

6. The control system of claim 1 wherein the patient input determines whether the operating hospital television is on or off.

7. The control system of claim 1 wherein the patient input can operate a channel function of the operating hospital television to move through available viewing channels of the operating hospital television.

8. The control system of claim 1 wherein the patient input can operate a volume function of the operating hospital television to move through available volume options of the operating hospital television.

9. The control system of claim 1 wherein the controller is operable for generating a third set of control signals for operating a radio device associated with the operating hospital television.

10. The control system of claim 1 wherein the controller is operable for generating a third set of control signals for selecting an operational function from available television operational functions.

11. The control system of claim 1 wherein said controller comprises a processor for processing said input signal to generate said control signals.

12. A hospital bed for controlling television models of a predetermined plurality of different models of hospital televisions that each have a distinct voltage level located proximate the bed, the hospital bed comprising:
a frame and a support surface coupled to the frame to receive a person;
an input device operable for generating at least one television input signal corresponding to a television input from a person;
a first set of control signals having at least one individual control signal designed to correspond to a first hospital television which is one of the predetermined number of hospital televisions;
a second set of control signals having at least one individual control signal designed to correspond to a second hospital television which is one of the predetermined number of hospital televisions;
a voltage reader device that determines the voltage level of a operating hospital television and depending on the voltage level configures a controller to transmit either the first set of control signals or the second set of control signals;
the control system automatically operating the operating hospital television in response to a patient input.

13. The bed of claim 12 wherein the second set of control signals further comprises a predetermined set of sequentially generated, individual control signals, each of the individual second set of control signals corresponds to at least one model of a predetermined plurality of different models of hospital televisions, one of which is the second hospital television and another is a third hospital television, but not the first hospital television.

14. The bed of claim 12 wherein the system has a third set of control signals having at least one individual control signal designed to correspond to a third hospital television which is one of the predetermined number of hospital televisions.

15. The bed of claim 12 wherein the first set of control signals further comprises a predetermined set of sequentially generated, individual control signals, each of the individual first set of control signals corresponds to at least one model of a predetermined plurality of different models of hospital televisions, one of which is the first hospital television and another is a third hospital television, but not the second hospital television.

16. The bed of claim 12 wherein the first set of control signals further comprises a predetermined set of sequentially generated, individual control signals, each of the individual first set of control signals corresponds to at least one model of a predetermined plurality of different models of hospital televisions, one of which is the first hospital television and another is a third hospital television, but not the second hospital television; and the second set of control signals further comprises a predetermined set of sequentially generated, individual control signals, each of the individual second set of control signals corresponds to at least one model of a predetermined plurality of different models of hospital televisions, one of which is the second hospital television and another is a fourth hospital television, but not the first hospital television.

17. The bed of claim 12 wherein the patient input determines whether the operating hospital television is on or off.

18. The bed of claim 12 wherein the patient input can operate a channel function of the operating hospital television to move through available viewing channels of the operating hospital television.

19. The bed of claim 12 wherein the patient input can operate a volume function of the operating hospital television to move through available volume options of the operating hospital television.

20. The bed of claim 12 wherein the controller is operable for generating a third set of control signals for operating a radio device associated with the operating hospital television.

21. The bed of claim 12 wherein the controller is operable for generating a third set of control signals for selecting an operational function from available television operational functions.

22. The bed of claim 12 wherein said controller comprises a processor for processing said input signal to generate said control signals.

23. A hospital pillow speaker to be used with a hospital bed for controlling television models of a predetermined plurality of different models of hospital televisions that each have a distinct voltage level located proximate the pillow speaker, the pillow speaker comprising:
a body including an interface surface for interfacing with a person;
an input device operable for generating at least one television input signal corresponding to a television input from a person;
a first set of control signals having at least one individual control signal designed to correspond to a first hospital television which is one of the predetermined number of hospital televisions;
a second set of control signals having at least one individual control signal designed to correspond to a second hospital television which is one of the predetermined number of hospital televisions;
a voltage reader device that determines the voltage level of a operating hospital television and depending on the voltage level configures a controller to transmit either the first set of control signals or the second set of control signals;
the control system automatically operating the operating hospital television in response to a patient input.

24. The pillow speaker of claim 23 wherein the second set of control signals further comprises a predetermined set of sequentially generated, individual control signals, each of the individual second set of control signals corresponds to at least one model of a predetermined plurality of different models of hospital televisions, one of which is the second hospital television and another is a third hospital television, but not the first hospital television.

25. The pillow speaker of claim 23 wherein the system has a third set of control signals having at least one individual control signal designed to correspond to a third hospital television which is one of the predetermined number of hospital televisions.

26. The pillow speaker of claim 23 wherein the first set of control signals further comprises a predetermined set of sequentially generated, individual control signals, each of the individual first set of control signals corresponds to at least one model of a predetermined plurality of different models of hospital televisions, one of which is the first hospital television and another is a third hospital television, but not the second hospital television.

27. The pillow speaker of claim 23 wherein the first set of control signals further comprises a predetermined set of sequentially generated, individual control signals, each of the individual first set of control signals corresponds to at least one model of a predetermined plurality of different models of hospital televisions, one of which is the first hospital television and another is a third hospital television, but not the second hospital television; and the second set of control signals further comprises a predetermined set of sequentially generated, individual control signals, each of the individual second set of control signals corresponds to at least one model of a predetermined plurality of different models of hospital televisions, one of which is the second hospital television and another is a fourth hospital television, but not the first hospital television.

28. The pillow speaker of claim 23 wherein the patient input determines whether the operating hospital television is on or off.

29. The pillow speaker of claim 23 wherein the patient input can operate a channel function of the operating hospital television to move through available viewing channels of the operating hospital television.

30. The pillow speaker of claim 23 wherein the patient input can operate a volume function of the operating hospital television to move through available volume options of the operating hospital television.

31. The pillow speaker of claim 23 wherein the controller is operable for generating a third set of control signals for operating a radio device associated with the operating hospital television.

32. The pillow speaker of claim 23 wherein the controller is operable for generating a third set of control signals for selecting an operational function from available television operational functions.

33. The pillow speaker of claim 23 wherein said controller comprises a processor for processing said input signal to generate said control signals.
